(19) United States
(12) Patent Application Publication
(10) Pub. No.: US 2024/0322403 A1
(43) Pub. Date: Sep. 26, 2024

(54) Fuse Device, Rechargeable Battery Pack with a Fuse Device and Method for Manufacturing a Fuse Device

(71) Applicant: Robert Bosch GmbH, Stuttgart (DE)

(72) Inventors: Anton Zwahr, Reutlingen (DE); Holger Wernerus, Pliezhausen (DE)

(21) Appl. No.: 18/531,239

(22) Filed: Dec. 6, 2023

(30) Foreign Application Priority Data
Dec. 15, 2022 (DE) 10 2022 213 705.1

(51) Int. Cl. H01M 50/574; H01H 85/00; H01H 85/02

(52) U.S. Cl. CPC H01M 50/574; H01H 85/0047; H01H 2085/0275; H01H 2085/0283; H01M 2200/103

(57) ABSTRACT

A fuse device for at least one battery cell includes (i) a fuse element for interrupting a current flow from the battery cell in a critical state of the battery cell, (ii) a heating unit, which is connected, in particular electrically and/or thermally and/or mechanically, to the fuse element, and is provided to assist a triggering of the fuse element, (iii) a control unit for activating the heating unit in the critical state, and (iv) at least one carrier element for receiving the fuse element and at least one heating element of the heating unit.

This application claims priority under 35 U.S.C. § 119 to patent application no. DE 10 2022 213 705.1, filed on Dec. 15, 2022 in Germany, the disclosure of which is incorporated herein by reference in its entirety.

### BACKGROUND

A fuse device has already been proposed for at least one battery cell, with a fuse element for interrupting a current flow from the battery cell in a critical state of the battery cell, having a heating unit, which is connected, in particular electrically and/or thermally and/or mechanically, to the fuse element, and is provided to assist a triggering of the fuse element, and having a control unit for activating the heating unit in the critical state.

### SUMMARY

The disclosure proceeds from a fuse device for at least one battery cell, with a fuse element for interrupting a current flow from the battery cell in a critical state of the battery cell, having a heating unit, which is connected, in particular electrically and/or thermally and/or mechanically, to the fuse element, and is provided to assist a triggering of the fuse element, and having a control unit for activating the heating unit in the critical state.

It is proposed that the fuse device comprises at least one carrier element for receiving the fuse element and at least one heating element of the heating unit.

The configuration of the fuse device according to the disclosure can advantageously increase safety. A triggering of the fuse element in the critical state of the battery cell can be advantageously favored or even made possible in the first place in certain critical states. Furthermore, advantageously, the problem of unprotected areas which exist with known fuse devices from the prior art, which can occur, for example, at certain charging states in combination with certain short-circuit resistors resulting from different triggering characteristics of different fuse elements, for example between a triggering characteristic of a fuse and the triggering characteristic of a CID (“Current Interruption device”) in conventional lithium ion rechargeable battery packs, can be solved. Furthermore, efficiency can advantageously be improved. In particular, the use of expensive non-standard components can be avoided, thus improving cost efficiency. In addition, a design of existing fuse elements can be advantageously simplified and thus efficiency in the development and/or manufacture can be improved.

The fuse device comprises the fuse element for interrupting a current flow in a critical state of the battery cell and can also comprise further fuse elements. The battery cell can be part of a rechargeable battery pack, and in particular in combination with other battery cells of the rechargeable battery pack, which can be electrically connected to the battery cell in parallel and/or in series. The fuse device is then advantageously also part of the rechargeable battery pack. It is conceivable that the fuse device is provided for multiple battery cells of the rechargeable battery pack. The rechargeable battery pack can also comprise multiple fuse devices, in particular one fuse device for each battery cell. Alternatively, the battery cell can also be individually operated and connected to the fuse device for protection. The fuse device is not limited to the use of a particular type of battery cell and/or rechargeable battery pack. The fuse device can, but is not limited to, be provided for use, for example with battery cells of lithium ion rechargeable batteries and/or lithium polymer rechargeable batteries and/or nickel cadmium rechargeable batteries and/or other known types of rechargeable battery that appear to be useful to the person skilled in the art. Also, the fuse device is not limited to a particular geometry and/or particular format of battery cells and/or rechargeable battery packs. For example, the battery cell can comprise different cell geometries and/or cell formats and can be configured as a rotary cell or flat cell or pouch cell or the like, for example.

The fuse element can, but is not limited to, be configured as, for example, a lead cutout fuse and/or a sheet metal strip fuse and/or a temperature-variable resistor, for example a PTC (positive temperature coefficient thermistor), and/or a copper track, in particular a narrowed one, on a printed circuit board. It is also conceivable that the fuse element is configured as a solder bridge or as a metal alloy, e.g. as a tin alloy, which has a defined resistance and thus a defined melting characteristic due to a defined cross-section and a defined length. In addition, the fuse element can be configured as a bi-metal component, which has a defined bending characteristic when the temperature changes and bends when exposed to heat, such that a current flow from the battery cell is interrupted.

A critical state of the battery cell can be, but is not limited to, an increased current and/or voltage compared to a normal state, for example, in particular a short-circuit of the battery cell, and/or overheating of the battery cell and/or a surrounding area of the battery cell and/or a positive pressure in the battery cell and/or the like.

The heating unit is provided to assist a triggering of the fuse element and comprises at least one heating element for this purpose. The heating unit can comprise multiple heating elements. The heating unit is provided to apply additional heat and/or electricity to the fuse element in a critical state of the battery cell, thereby favoring triggering of the fuse element and thus interrupting the current flow from the battery cell. For example, the heating element of the heating unit can have a corresponding structure for applying heat and/or electricity to the fuse element in the critical state of the battery cell, and can comprise one or more materials having corresponding electrical and/or thermal properties, for example copper and/or aluminum and/or silver and/or the like, and/or be formed from such materials. For example, the heating element can be configured as a wire or as a spiral and/or meander-shaped copper structure. If the carrier element is configured as a printed circuit board, the heating element can also be configured as a copper track of any shape, for example, a rectilinear or zigzag copper track, or the like.

Alternatively or additionally, the heating element can also be configured as a heatable component, for example as a resistor, in particular temperature-variable resistor, and/or as a semiconductor component and/or the like. Preferably, a heating power of the heating unit is determined by a resistance design in connection with an available voltage of the battery cell and/or the rechargeable battery pack comprising the battery cell.

The heating element of the heating unit is coupled to the fuse element, in particular electrically and/or thermally and/or mechanically. For example, the heating element can be coupled to the fuse element by direct contact, for example via a soldered connection and/or plug connection and/or weld connection and/or via a direct mechanical contact. Alternatively or additionally, the heating element can be thermally coupled to the fuse element via one or more components with good thermal conductivity and/or by means of thermal conductive paste and/or the like.

To supply power, the heating element is preferably electrically connected to at least one electrical connector of the battery cell, at least in the critical state of the battery cell. The heating element can be connected to the at least one electrical connector of the battery cell via common connection types, for example via a solder connection and/or a weld connection and/or via a press-in pin and/or a screw contact and/or via corresponding copper webs and/or the like.

Alternatively, however, it would also be conceivable for the fuse device to have a separate power supply, for example a separate rechargeable battery and/or a separate battery, to supply the heating unit, and for the heating element to be connected to the power supply via corresponding connection types.

The control unit is provided for activating the heating unit and preferably comprises at least one switching element for this purpose, which is provided for establishing an electrically conductive connection between the heating element of the heating unit and an electrical connection of the battery cell in a critical state of the battery cell for activating the heating unit.

The switching element can be configured as a relay, for example. Preferably, the switching element is configured as a semiconductor switching element, for example a transistor or the like.

The control unit can be provided to control the switching element by means of a modulation technique, for example by means of pulse width modulation, in order to control and/or regulate a heating power of the heating unit. It is conceivable that the control unit comprises a measurement unit for measuring at least one parameter of the heating unit, for example an electrical current and/or an electrical voltage and/or a temperature of the heating unit, wherein the control unit can be provided for regulating the heating unit based on the parameter detected by the measurement unit. Preferably, the control unit is provided to control the heating unit for a limited period of time, for example for 30 s, in particular to limit an input of energy of the heating unit to the fuse element and/or other components of the fuse device and/or rechargeable battery pack.

The carrier element of the fuse device is provided for receiving the fuse element and the at least one heating element of the heating unit and has a corresponding structure for this purpose. It is also conceivable that the fuse element and/or the heating element are configured integrally with the carrier element. The term “integral” is in particular understood to mean connected at least by substance-to-substance bonding, e.g., by a welding process, an adhesive bonding process, a process of molding on and/or another process that appears advantageous to the skilled person skilled, and/or advantageously formed in one piece, e.g., by production from a casting and advantageously from a single blank.

In the present document, numeral words such as “first” and “second” which precede certain terms are merely used in order to distinguish objects and/or assign objects to one another and do not imply an existing total number and/or ranking of the objects. In particular, a “second object” does not necessarily imply the presence of a “first object.”

“Provided” is to be understood as meaning specifically configured, specifically designed and/or specifically equipped. When an object is provided for a particular function, this is to be understood as meaning that the object fulfills and/or performs that particular function in at least one application and/or operating state.

It is further proposed that the carrier element is configured as a printed circuit board. This can advantageously enable an adjustment of the fuse device to various requirements with particularly simple technical means. The printed circuit board can be configured as a rigid printed circuit board (rigid PCB) or a flexible printed circuit board (flex PCB). Preferably, the fuse element is applied to the printed circuit board as a copper structure, in particular as a narrowed copper track. The heating element can also be applied to the printed circuit board as a copper structure of any shape, for example rectilinear or zigzag, advantageously as a spiral and/or meander-shaped copper structure. It is also conceivable that the heating element is configured as an electrical and/or electronic component, for example as a resistor, in particular temperature-variable resistor, and/or as a semiconductor component and/or the like, and the printed circuit board is equipped with such a component. The fuse element and the heating element can be arranged on different sides of the printed circuit board or on the same side of the printed circuit board. The printed circuit board can be single-layered or multi-layered.

In an alternative advantageous configuration, it is proposed that the fuse element is configured integrally with the carrier element. This can advantageously enable a particularly simple and efficient manufacture of the fuse device. For example, the fuse element can be configured as a sheet metal strip fuse and the heating element can be arranged on and/or around the fuse element, for example as an insulated wire. It is also conceivable that the heating element is configured from branched parts of the fuse element configured as a metal sheet strip fuse and is arranged on and/or around the fuse element, wherein the heating element is electrically isolated from heated areas of the fuse element, for example by an insulation layer or insulation sleeve.

In addition, it is proposed that the fuse device comprises a sensor unit for detecting at least one status parameter of the battery cell and the control unit comprises a microprocessor for characterizing the state of the battery cell based on the status parameter detected by the sensor unit. Safety can advantageously be further increased by such a configuration. In particular, a status of the battery cell can be specifically monitored, a presence of a critical state can be reliably detected, and in this case, a particularly precise triggering of the fuse element can be enabled. Status parameters of the battery cell can, but are not limited to, comprise, for example, a temperature and/or a pressure and/or an electrical voltage and/or an electrical current and/or the like. The sensor unit preferably comprises one or more sensors to detect the at least one status parameter, which, depending on the type of status parameter, are configured accordingly and arranged at corresponding points on and/or in the battery cell and/or electrically connected to the battery cell. Alternatively or additionally, it would also be conceivable that at least one switching element of the control unit, which is configured as a semiconductor component, for example a transistor, functions as a sensor and is provided to automatically activate the heating unit when its threshold voltage, which is configured for a critical state of the battery cell, is exceeded, in particular without characterization of the state of the battery cell by the microprocessor.

Furthermore, it is proposed that the fuse device comprises at least one insulator for electrically insulating the fuse element and the heating element from each other. This can advantageously further increase safety. In particular, a short-circuit between the fuse element and the heating element can be prevented. Depending on the configuration of the fuse element and/or the heating element, the insulator can be configured in various ways. For example, the insulator can be configured as part of a jacket when the heating element is configured as a wire. In an advantageous configuration, it is proposed that the carrier element functions as the insulator. By such a configuration, an efficiency, in particular with regard to a cost of material and/or manufacturing and associated costs, can be advantageously further improved.

It is further proposed that the fuse device has at least one reaction element which is applied to the fuse element at least in a partial area and is provided to react with the fuse element under the thermal influence of the heating unit and to change its physical and/or chemical properties in order to favor triggering. Flexibility can advantageously be increased by such a configuration. In particular, triggering characteristics of the fuse element can be varied as required, even if the structure of the fuse element remains the same. In the event of a critical state of the battery cell, the reaction element can, for example, be provided to change the physical and/or chemical properties of the fuse element under the thermal influence of the heating unit in the form of a reduction in the melting point of the contacting element, for example by forming an alloy with the fuse element, in order to favor triggering. For example, the reaction element can be formed from tin and react under the thermal influence of the heating unit with the fuse element comprising copper and/or consisting of copper to form a tin bronze with a melting point lower than pure copper. It is also conceivable that, in the event of a critical state of the battery cell, the reaction element is provided to change the physical and/or chemical properties of the fuse element in the form of an increase in the brittleness of the fuse element in order to favor a breakage of the fuse element and thus its triggering. For example, the reaction element can be formed from gallium, partially liquefy under thermal influence of the heating unit and partially diffuse into the fuse element comprising aluminum and/or consisting of aluminum, thus favoring a brittle fracture of the fuse element and thus its triggering. The reaction element can be applied to the fuse element in a partial area or in multiple partial areas, for example in the form of one or more solder points or the like, or over the entire surface, for example by coating.

In addition, it is proposed that the heating element and the fuse element are configured as copper layers and arranged on the carrier element in layers adjacent to each other, wherein the copper layers can have different thicknesses. Advantageously, a particularly flexible configuration of the fuse device and, in particular, a simple adaptation to different requirements can be enabled as a result. It is also conceivable that some or all copper layers have the same thickness. Preferably, the carrier element in this configuration is configured as a multi-layered printed circuit board and comprises at least two layers. In the case of more than two layers, the fuse element is preferably arranged in an outer layer, for example to enable a thickening of the fuse element configured as a copper layer by means of galvanic processes and thus, if necessary, to increase the current carrying capacity of the fuse element. In this configuration, the fuse device can, for example, also comprise a further fuse element, which is then preferably arranged in a further outer layer. For example, the fuse element can be arranged in an uppermost layer and the further fuse element in a lowermost layer, wherein in each case at least one further layer is arranged adjacent to the uppermost layer and/or the lowermost layer, on which the heating element and possibly at least one further heating element is/are arranged. The fuse element and the heating element are advantageously configured as copper layers of different copper thickness. In this context, the term “copper thickness” refers to a unit used in printed circuit board technology, which describes a weight of a copper layer per area of the printed circuit board and which is specified in oz/ft² or in g/m². The thickness of the copper layer can be derived from the copper thickness. For example, the fuse element formed as a first copper layer can have a copper thickness of 2 oz/ft², which corresponds to about 610 g/m², and thus a thickness of approximately 70 m. For example, the heating element can be formed as a second copper layer having a copper thickness of 0.5 oz/ft², which corresponds to about 152 g/m², and thus a thickness of approximately 17.5 m.

Furthermore, it is proposed that the fuse element be provided for connection to an electrically positive connector of the battery cell and that the control unit has a switching element configured as an NPN bipolar transistor or as an N-channel MOSFET. This can advantageously allow for a particularly simple activation of the heating unit in the critical state of the battery cell in the event that the fuse element is provided for connection to an electrically positive connector of the battery cell. In an alternative advantageous configuration, it is proposed that the fuse element be provided for connection to an electrically negative connector of the battery cell and that the control unit has a switching element configured as a PNP bipolar transistor or as a P-channel MOSFET. This can advantageously allow for a particularly simple activation of the heating unit in the critical state of the battery cell in the event that the fuse element is provided for connection to an electrically negative connector of the battery cell.

Furthermore, it is proposed that the heating unit is provided for direct heating of an area of the fuse element. Advantageously, a particularly reliable triggering of the fuse element in a critical state of the battery cell can thus be enabled. The area of the fuse element for which the heating unit is provided for direct heating is preferably a so-called hotspot of the fuse element. Alternately or additionally, it is proposed that the heating unit is provided for the direct heating of at least one surrounding area of the fuse element. If the heating unit is provided for direct heating of the at least one surrounding area of the fuse element, the fuse element can be heated indirectly by heat conduction, in particular via at least one further element, for example the carrier element. If the heating unit is provided solely for heating at least one surrounding area of the fuse element, it is advantageous to avoid direct contact between the hotspot of the fuse element and the heating element, which otherwise could lead to exceeding the temperature stability of the heating element. If the heating unit is provided to heat at least one surrounding area of the fuse element in addition to heating the area of the fuse element, particularly reliable triggering can be further favored.

Furthermore, it is proposed that the fuse element is provided to disconnect an electrically conductive connection between the heating unit and the battery cell when triggered. This can advantageously further increase safety even more. In particular, the heating can be prevented from continuing to be supplied with electrical power after the triggering of the fuse element and the associated hazards, for example a fire hazard, can be effectively prevented.

The disclosure further relates to a rechargeable battery pack having at least one battery cell and having at least one fuse device connected to the battery cell according to any of the configurations described above. Such a rechargeable battery pack is in particular characterized by its advantageous properties with regard to safety, which can be achieved by the fuse device according to the disclosure.

The disclosure also relates to a method for manufacturing a fuse device for a battery cell, in particular according to any of the configurations described above, wherein a fuse element and at least one heating element of a heating unit are applied to a printed circuit board. Using such a method, the fuse device according to the disclosure can be manufactured particularly simply and efficiently. The method preferably comprises at least two process steps. The fuse element can be applied to the printed circuit board in a first process step, for example in the form of a copper track or the like, in particular using suitable processes known from the prior art. In a subsequent second process step, the heating element can be applied to the printed circuit board, for example in the form of a further copper track or in the form of an electrical and/or electronic component, for example as a resistor, in particular a temperature-variable resistor, and/or as a semiconductor component or the like.

The fuse device according to the disclosure is not to be limited to the above-described application and embodiment. In order to fulfill a functionality described herein, the fuse device according to the disclosure can in particular comprise a number of individual elements, components, and units as well as process steps that deviate from a number mentioned herein. Moreover, regarding the ranges of values indicated in this disclosure, values lying within the aforementioned limits are also intended to be considered as disclosed and usable as desired.

### BRIEF DESCRIPTION OF THE DRAWINGS

Further advantages follow from the description of the drawings hereinafter. The drawings illustrate six embodiment examples of the disclosure. The drawings, the description, and the claims contain numerous features in combination. The skilled person will appropriately also consider the features individually and combine them into additional advantageous combinations.

Shown are:

FIG. 1 a rechargeable battery pack having at least one battery cell and a fuse device connected to the battery cell in a schematic perspective representation,

FIG. 2 a schematic block diagram of the fuse device,

FIG. 3 the fuse device in a schematic top view and a schematic side view,

FIG. 4 a schematic method flow chart for illustrating a method for manufacturing the fuse device,

FIG. 5 a further embodiment example of a fuse device in a schematic top view and a schematic side view,

FIG. 6 a further embodiment example of a fuse device in two schematic top views and a schematic side view,

FIG. 7 a further embodiment example of a fuse device in two schematic top views and a schematic side view,

FIG. 8 a further embodiment example of a fuse device in a schematic representation, and

FIG. 9 a further embodiment example of a fuse device in a schematic diagram.

### DETAILED DESCRIPTION

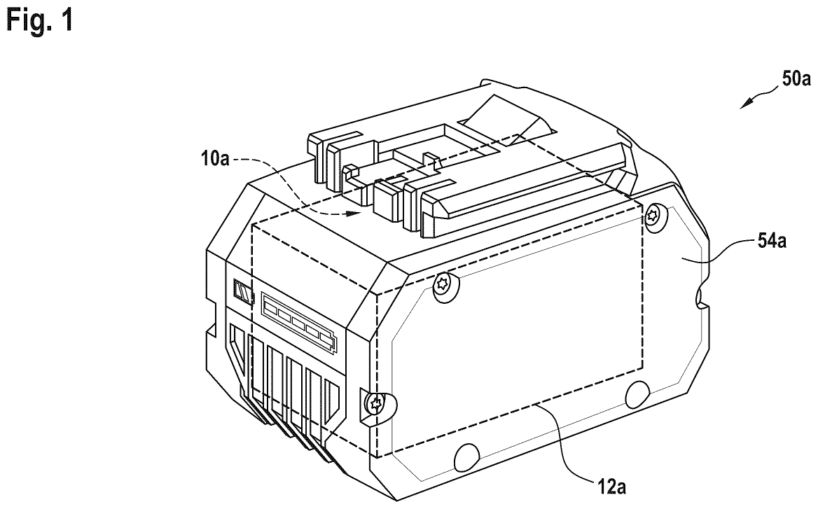

FIG. 1 shows a rechargeable battery pack 50a having at least one battery cell 12a and having at least one fuse device 10a connected to the battery cell 12a in a schematic perspective representation. In the present case, the rechargeable battery pack 50a is configured, for example, as a hand-held power tool rechargeable battery pack. Alternatively, however, it is also conceivable that the rechargeable battery pack 50a is configured as a different rechargeable battery pack that appears reasonable to a person skilled in the art. The rechargeable battery pack 50a comprises a housing 54a in which the at least one battery cell 12a and the fuse device 10a are arranged.

The rechargeable battery pack 50a can include a plurality of battery cells 12a electrically connected in series with each other and/or electrically in parallel. The rechargeable battery pack 50a can have its own fuse device 10a for each battery cell 12a. It is also conceivable that the fuse device 10a is provided for protecting multiple battery cells 12a of the rechargeable battery pack 50a. The following description is limited for the sake of simplicity to a fuse device 10a for a battery cell 12a of the rechargeable battery pack 50a.

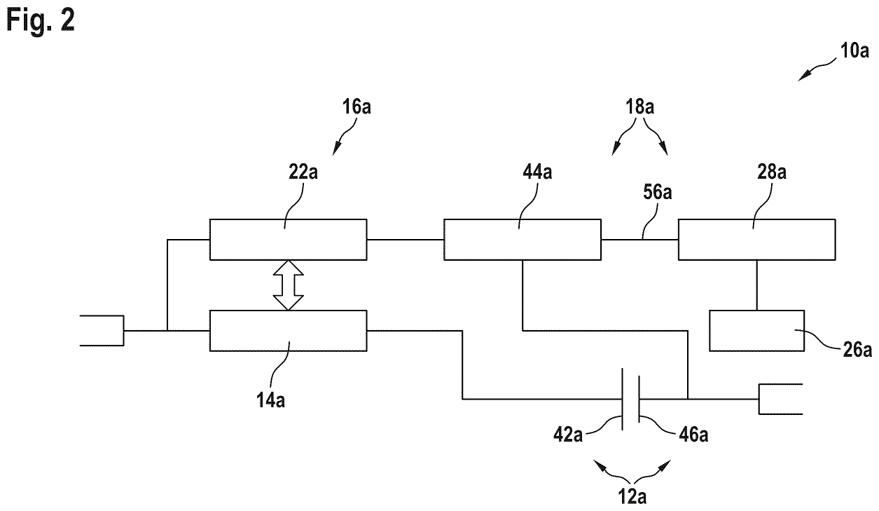

FIG. 2 shows a schematic block diagram of the fuse device 10a for the at least one battery cell 12a. The fuse device 10a comprises a fuse element 14a for interrupting a current flow from the battery cell 12a in a critical state of the battery cell 12a. A critical state can, but is not limited to, be a short-circuit of battery cell 12a, for example, and/or an overheating of battery cell 12a, and/or a positive pressure of battery cell 12a, and/or the like.

The fuse device 10a further comprises a heating unit 16a. The heating unit 16a is coupled to the fuse element 14a. The heating unit 16a comprises at least one heating element 22a. In the present case, the heating element 22a of the heating unit 16a is thermally coupled to the fuse element 14a. The heating unit 16a is provided to assist a triggering of the fuse element 14a.

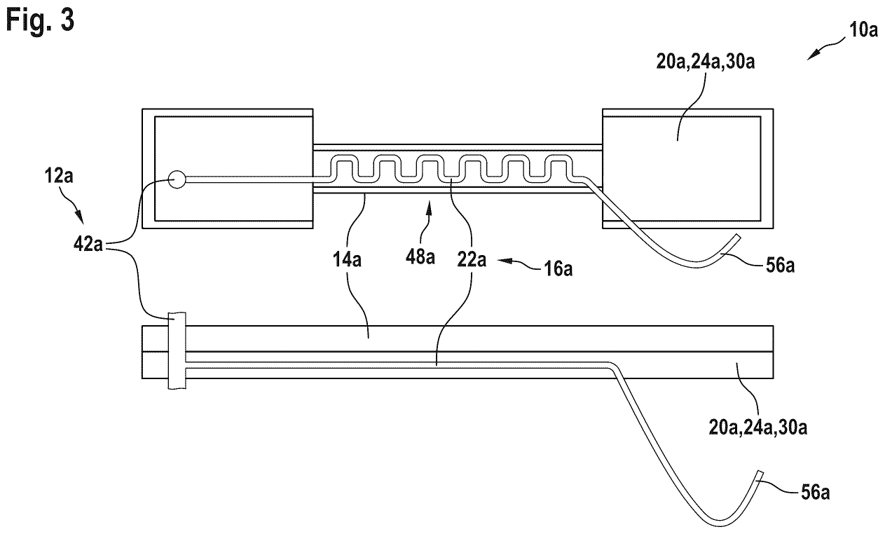

The fuse device 10a comprises at least one carrier element 20a (see FIG. 3) for receiving the fuse element 14a and at least one heating element 22a of the heating unit 16a.

The battery cell 12a has an electrically positive connector 42a and an electrically negative connector 46a. The heating unit 16a is connected to at least one of the connectors 42a, 46a of the battery cell 12a for the power supply.

The fuse device 10a also comprises a control unit 18a for activating the heating unit 16a in the critical state. The control unit 18a comprises at least one switching element 44a. In the critical state, the control unit 18a activates the heating unit 16a via the switching element 44a.

In the present case, the fuse element 14a is provided for connection to an electrically positive connector 42a of the battery cell 12a and the switching element 44a of the control unit 18a is configured as an NPN bipolar transistor or as a N-channel MOSFET. Alternatively, the fuse element 14a is provided for connection to an electrically negative connector 46a of the battery cell 12a, wherein the switching element 44a of the control unit 18a is then configured as a PNP bipolar transistor or as a P-channel MOSFET.

The fuse device 10a comprises a sensor unit 26a for detecting at least one status parameter of the battery cell 12a. For example, a status parameter of battery cell 12a can be a temperature and/or a pressure and/or an electrical voltage and/or an electrical current. The sensor unit 26a comprises one or more sensors (not shown) for detecting the at least one status parameter, which can be arranged on and/or in the battery cell 12a and configured accordingly depending on the type of status parameter to be detected.

The control unit 18a comprises a microcontroller 28a. The microprocessor 28a is provided to characterize the state of the battery cell 12a based on the status parameter detected by the sensor unit 26a. The microprocessor 28a is connected to the switching element 44a via a control line 56a of the control unit 18a. In one operating state of the fuse device 10a, the microprocessor 28a monitors the at least one status parameter. If the at least one status parameter exceeds a predetermined limit value, for example a maximum allowable temperature of the battery cell 12a stored in a memory of the microprocessor 28a, the microprocessor detects that a critical state of the battery cell 12a is present and activates the heating unit 16a via the switching element 44a.

FIG. 3 shows the fuse device 10a in two schematic views. In an upper view of FIG. 3, the fuse device 10a is shown in a schematic plan view. A lower view of FIG. 3 shows the fuse device 10a in a schematic side view.

In the present case, the carrier element 20a of the fuse device 10a is configured as a printed circuit board 24a. In the present case, the fuse element 14a and the at least one heating element 22a of the heating unit 16a are arranged together on the printed circuit board 24a.

The fuse device 10a comprises at least one insulator 30a for electrically insulating the fuse element 14a and the heating element 22a from each other. In the present case, the carrier element 20a, i.e. the printed circuit board 24a, functions as the insulator 30a.

In the present embodiment example, the heating unit 16a is provided for direct heating of an area 48a of the fuse element 14a.

The fuse element 14a is provided to disconnect an electrically conductive connection between the heating unit 16a and the battery cell 12a when triggered. In the present case, the fuse element 14a is provided to disconnect an electrically conductive connection, via which the at least one heating element 22a of the heating unit 16a is connected to the positive connection point 42a of the battery cell 12a when triggered, such that when the fuse element 14a is triggered, not only a current flow is interrupted from the battery cell 12a to external consumers, for example, a power unit of a hand-held power tool (not shown), which is powered by means of the rechargeable battery pack 50a (cf. FIG. 1), but a current flow from the battery cell 12a to the heating unit 16a is also interrupted.

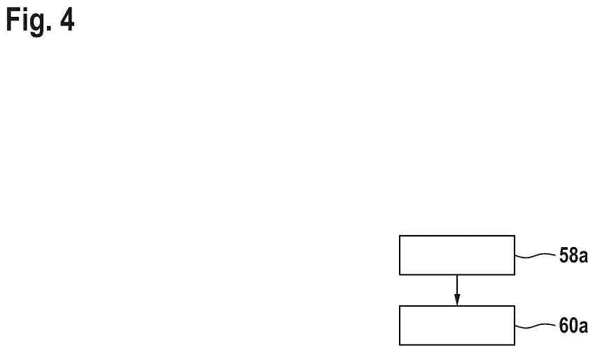

FIG. 4 shows a schematic method flow chart of a method for manufacturing the fuse device 10a for the battery cell 12a. The method comprises at least two process steps 58a, 60a. In a first process step 58a of the method, the fuse element 14a is applied to the printed circuit board 24a, for example as a narrowed copper track. In a second process step 60a of the method, the at least one heating element 22a of the heating unit 16a, for example in the form of a copper structure, which can be, for example, spiral or meander-shaped, is applied to the printed circuit board 24a.

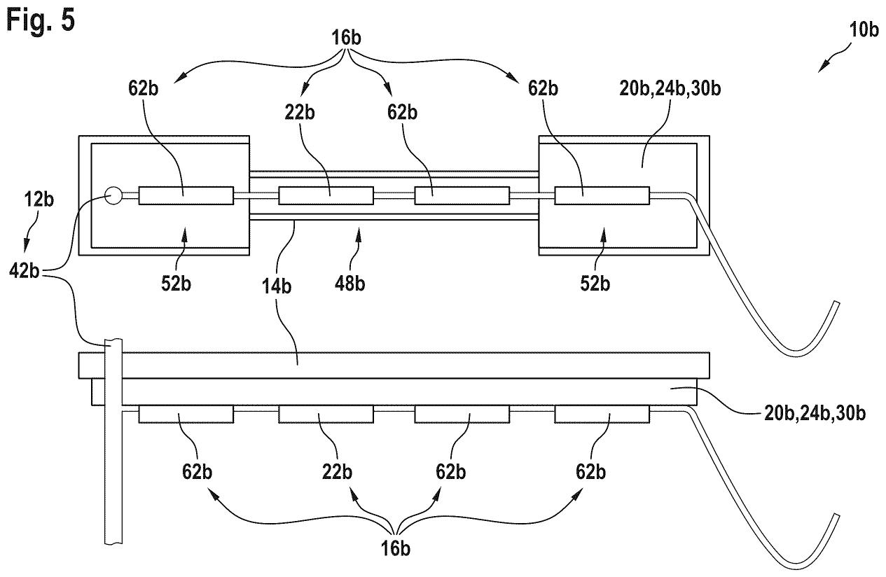

FIGS. 5 to 9 show five further embodiment examples of the disclosure. The following descriptions and the drawings are essentially limited to the differences between the embodiment examples, wherein reference can, in principle, also be made, with respect to identically designated components, in particular with respect to components having the same reference numbers, to the drawings and/or the description of the other embodiment examples, in particular FIGS. 1 to 4. In order to distinguish the embodiment examples, the letter a is appended to the reference numbers of the embodiment example in FIGS. 1 to 4. In the embodiment examples of FIGS. 5 to 9, the letter a is replaced by the letters b to f.

FIG. 5 shows a further embodiment example of a fuse device 10b for a battery cell 12b in two schematic views. In an upper view of FIG. 5, the fuse device 10b is shown in a schematic plan view. A lower view of FIG. 5 shows the fuse device 10b in a schematic side view.

Analogously to the preceding embodiment example, the fuse device 10b comprises a fuse element 14b for interrupting a current flow from the battery cell 12b in a critical state of the battery cell 12b and a heating unit 16b coupled to the fuse element 14b and is provided to assist a triggering of the fuse element 14b. The heating unit 16b comprises at least one heating element 22b.

The fuse device 10b also comprises a control unit. The control unit of the fuse device 10b is not shown in FIG. 5 and with regard to its function, reference is made to the above description for the control unit 18a in the first embodiment example.

The fuse device 10b in turn comprises at least one carrier element 20b for receiving the fuse element 14b and the at least one heating element 22b of the heating unit 16b. Analogously to the preceding embodiment example, the carrier element 20b is configured as a printed circuit board 24b, which also functions as an insulator 30b to electrically insulate the fuse element 24b and the heating element 22b from each other.

In contrast to the first embodiment example, the heating unit 16b additionally comprises multiple further heating elements 62b in addition to the heating element 22b. The further heating elements 62b are also arranged on the carrier element 20b configured as a printed circuit board 24b.

A further difference from the previous embodiment example is that the heating element 22b and the further heating elements 62b of the heating unit 16b are not configured as copper structures but as temperature-variable resistors, for example as PTCs.

In the present embodiment example, the heating unit 16b is in turn provided for direct heating of an area 48b of the fuse element 14b. The heating of the area 48b of the fuse element 14b is carried out in a critical state of the battery cell 12b by means of the heating element 22b of the heating unit 16b. In addition, the heating unit 16b is also provided for direct heating of at least one surrounding area 52b of the fuse element 14b. The heating of the at least one surrounding area 52b of the fuse element 14b is carried out in a critical state of the battery cell 12b by means of the further heating element 62b of the heating unit 16b, wherein assistance for triggering the fuse element 14b is favored by heat conduction of the printed circuit board 24b from the surrounding area 52b to the fuse element 14b. It would also be conceivable that the heating element 22b and the heating elements 62b of the heating unit 16b are exclusively provided for direct heating of at least one surrounding area 52b of the fuse element 14b and are arranged accordingly, for example to avoid exceeding a temperature stability of the heating elements 22b, 62b in the critical state.

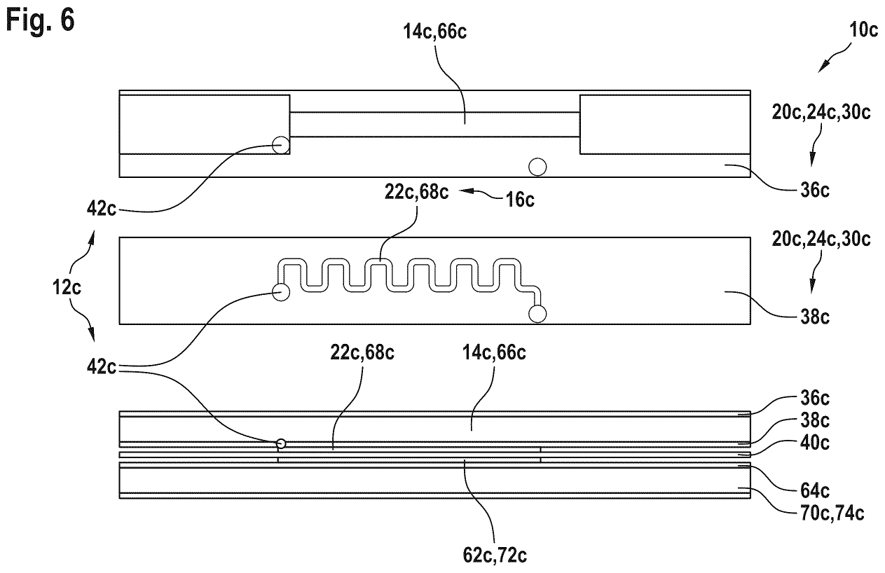

FIG. 6 shows a further embodiment example of a fuse device 10c for a battery cell 12c in three schematic views.

Analogously to the preceding embodiment examples, the fuse device 10c comprises a fuse element 14c for interrupting a current flow from the battery cell 12c in a critical state of the battery cell 12c and a heating unit 16c coupled to the fuse element 14c and is provided to assist a triggering of the fuse element 14c.

The heating unit 16c in turn comprises at least one heating element 22c.

The fuse device 10c, analogous to the preceding embodiment examples, comprises at least one carrier element 20c for receiving the fuse element 14c and the at least one heating element 22c of the heating unit 16c. The carrier element 20c is configured as a printed circuit board 24c, which also functions as an insulator 30c to electrically insulate the fuse element 24c and the heating element 22c from each other.

The fuse device 10c also comprises a control unit. The control unit of the fuse device 10c is not shown in FIG. 6 and with regard to its function, reference is made to the above description for the control unit 18a in the first embodiment example.

In contrast to the previous embodiment examples, the printed circuit board 24c is configured in multiple layers, in the present case for example four layers. A top view of FIG. 6 shows a first layer 36c of the printed circuit board 24c in a schematic top view. The fuse element 14c is formed as a first copper layer 66c and is arranged on the first layer 36c of the printed circuit board 24c.

A middle view of FIG. 6 shows a second layer 38c of the printed circuit board 24c in a schematic top view. The heating element 22c of the heating unit 16c is formed as a second copper layer 68c and is arranged on the second layer 38c of the printed circuit board 24c.

A lower view of FIG. 6 shows the carrier element 20c configured as a multi-layered printed circuit board 24c in a schematic side view. The heating element 22c and the fuse element 24c are arranged in adjacent layers 36c, 38c on the carrier element 20c.

The first copper layers 66c and the second copper layer 68c have different thicknesses. In the present case, the fuse element 14c configured as the first copper layer 66c has a greater thickness than the heating element 22c configured as the second copper layer 68c. For example, the first copper layer 66c having a copper thickness of 2 oz/ft², which corresponds to about 610 g/m², can be applied to the first layer 36c of the printed circuit board 24c and have a thickness of approximately 70 μm, and the second copper layer 68c having a copper thickness of 0.5 oz/ft², which corresponds to approximately 152 g/m² can be applied to the second layer 38c of the printed circuit board 24c and have a thickness of approximately 17.5 μm.

In the present case, the heating unit 16c comprises a further heating element 62c, which is applied to a third layer 40c of the printed circuit board 24c as a third copper layer 72c. In the present case, a thickness of the third copper layer 72c corresponds to the thickness of the second copper layer 68c.

In the present case, the fuse device 10c comprises a further fuse element 70c, which is applied to a fourth layer 64c of the printed circuit board 24c as the fourth copper layer 74c. In the present case, a thickness of the fourth copper layer 74c corresponds to the thickness of the first copper layer 66c. In the present case, the further heating element 62c of the heating unit 16c is provided to assist a triggering of the further fuse element 70c. The further fuse element 70c and the further heating element 62c are arranged in adjacent layers 40c, 64c on the carrier element 20c.

In the present case, the fuse element 14c and the further fuse element 70c of the fuse device 10c are each arranged in the outer layers, i.e. in the first layer 36c and the fourth layer 64c, of the printed circuit board 24c. This makes it possible to thicken the first copper layer 66c and/or the fourth copper layer 74c, for example, by means of galvanic processes, in order to increase the current carrying capacity of the fuse element 14c and/or the further fuse element 70c, if necessary.

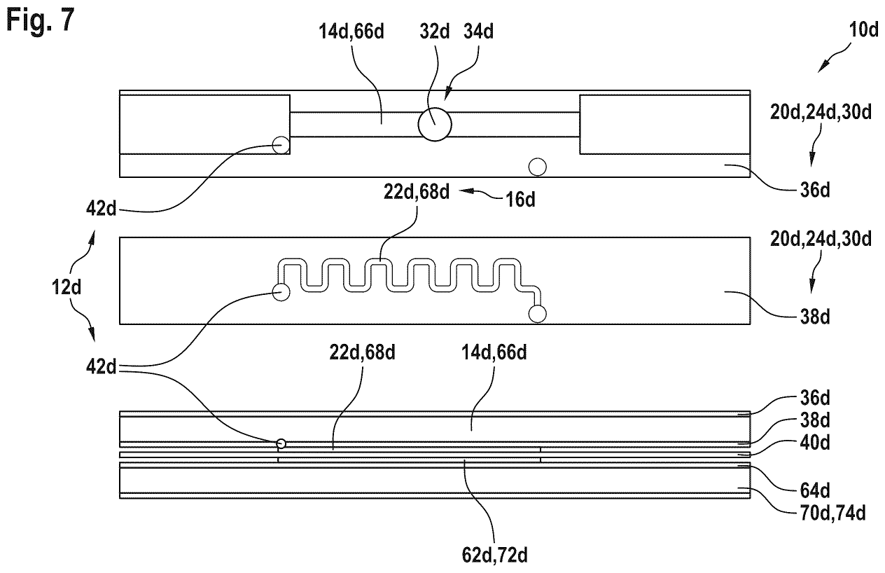

FIG. 7 shows a further embodiment example of a fuse device 10d for a battery cell 12d in three schematic views.

Analogously to the preceding embodiment examples, the fuse device 10d comprises a fuse element 14d for interrupting a current flow from the battery cell 12d in a critical state of the battery cell 12d and a heating unit 16d coupled to the fuse element 14d and is provided to assist a triggering of the fuse element 14d.

The heating unit 16d in turn comprises at least one heating element 22d.

The fuse device 10d, analogous to the preceding embodiment examples, comprises at least one carrier element 20d for receiving the fuse element 14d and the at least one heating element 22d of the heating unit 16d. The carrier element 20d is configured as a printed circuit board 24d, which also functions as an insulator 30d to electrically insulate the fuse element 24d and the heating element 22d from each other.

The fuse device 10d also comprises a control unit not shown in FIG. 7, so that with regard to its function, reference is made to the above description for the control unit 18a in the first embodiment example.

Analogously to the preceding embodiment example, the printed circuit board 24d is configured in multiple layers. With regard to the printed circuit board 24d, the fuse device 10d has a substantially identical structural design to the fuse device 10c, which is why reference is made to the above description of FIG. 6.

In contrast to the preceding embodiment example, the fuse device 10d comprises at least one reaction element 32d. The reaction element 32d is provided to react with the fuse element 14d under thermal influence of the heating unit 16d and to change its physical and/or chemical properties in order to favor triggering of the fuse element 14d.

In the present case, the reaction element 32d is applied to the fuse element 14d in a partial area 34d. Alternatively or additionally, however, the reaction element 32d could also be applied to the fuse element 14d in further partial areas (not shown) of the fuse element 14d or over the entire surface, for example as a coating.

In the present case, the reaction element 32d is formed from tin. For example, the reaction element can be applied to the fuse element 14d as a solder point. Under the thermal influence of the heating unit 16d, the reaction element 32d formed from tin reacts with the fuse element 14d configured as a copper layer 66d in the partial area to form a tin bronze, which has a lower melting point than the pure copper of the fuse element 14d.

The reaction element 32d is only shown in the present embodiment example of FIG. 7, wherein the person skilled in the art will recognize that the function of the reaction element 32d as such is not limited to the specific structure of the fuse device 10d and can also be applied to all of the preceding and subsequent embodiment examples accordingly.

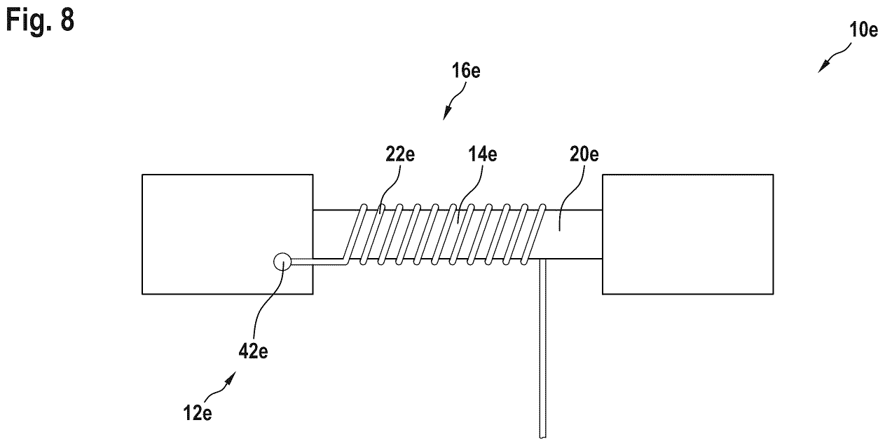

FIG. 8 shows another embodiment example of a fuse device 10e for a battery cell 12e in a schematic representation.

Analogously to the preceding embodiment examples, the fuse device 10e comprises a fuse element 14e for interrupting a current flow from the battery cell 12e in a critical state of the battery cell 12e and a heating unit 16e coupled to the fuse element 14e and is provided to assist a triggering of the fuse element 14e.

The heating unit 16e in turn comprises at least one, in the present case precisely one, heating element 22e.

The fuse device 10e, analogous to the preceding embodiment examples, comprises at least one carrier element 20e for receiving the fuse element 14e and the at least one heating element 22e of the heating unit 16e.

In contrast to the previous embodiment examples, the fuse element 14e is configured integrally with the carrier element 14e. In the present case, the fuse element 14e is configured as a sheet metal strip fuse.

In the present case, the heating element 22e of the heating unit 16e is configured as an electrically insulated wire and is placed directly on the fuse element 14e, for example wrapped around the fuse element 14e. An insulation layer (not shown) of the wire also functions as an insulator of the fuse device 10e for electrically insulating the fuse element 14e and the heating element 22e from each other.

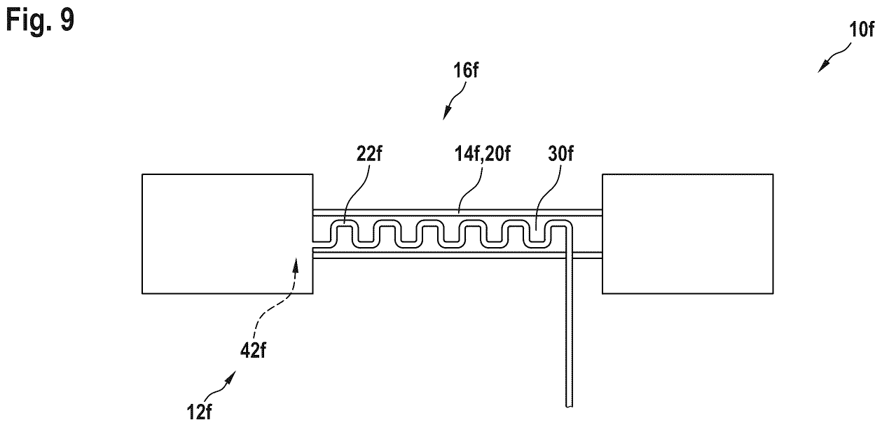

FIG. 9 shows another embodiment example of a fuse device 10f for a battery cell 12f in a schematic representation.

Analogously to the preceding embodiment examples, the fuse device 10f comprises a fuse element 14f for interrupting a current flow from the battery cell 12f in a critical state of the battery cell 12f and a heating unit 16f coupled to the fuse element 14f and is provided to assist a triggering of the fuse element 14f.

The heating unit 16f in turn comprises at least one, in the present case precisely one, heating element 22f.

The fuse device 10f, analogous to the preceding embodiment examples, comprises at least one carrier element 20f for receiving the fuse element 14f and the at least one heating element 22f of the heating unit 16f.

As in the preceding embodiment example of FIG. 8, the fuse element 14f is configured integrally with the carrier element 14f. In the present case, the fuse element 14f is configured as a sheet metal strip fuse.

The heating element 22f of the heating unit 16f is configured directly from branched parts of the fuse element 14f in contrast to the preceding embodiment example of FIG. 8.

The fuse device 10f comprises at least one insulator 30f for electrically insulating the fuse element 14f and the heating element 22f from each other. In the present case, the insulator 30f is configured as an insulation layer, which is arranged between the fuse element 14f and the heating element 22f of the heating unit 16f.

What is claimed is:

1. A fuse device for at least one battery cell, comprising:
a fuse element configured to interrupt a current flow from the at least one battery cell in a critical state of the at least one battery cell;
a heating unit connected to the fuse element and configured to assist a triggering of the fuse element, wherein the heating unit includes at least one heating element;
a control unit configured to activate the heating unit in the critical state; and
at least one carrier element configured to receive the fuse element and the at least one heating element.

2. The fuse device according to claim 1, wherein the at least one carrier element is configured as a printed circuit board.

3. The fuse device according to claim 1, wherein the fuse element is configured integrally with the at least one carrier element.

4. The fuse device according to claim 1, further comprising a sensor unit configured to detect at least one status parameter of the at least one battery cell, wherein:
the control unit comprises a microprocessor configured to characterize the state of the at least one battery cell based on the at least one status parameter detected by the sensor unit.

5. The fuse device according to claim 1, further comprising at least one insulator configured to electrically insulate the fuse element and the at least one heating element from each other.

6. The fuse device according to claim 5, wherein the at least one carrier element is configured to function as the at least one insulator.

7. The fuse device according to claim 1, further comprising at least one reaction element which is applied to the fuse element at least in a partial area and is configured and arranged to react with the fuse element under thermal influence of the heating unit and to change its physical and/or chemical properties in order to favor triggering.

8. The fuse device according to claim 1, wherein the at least one heating element and the fuse element are formed as copper layers and are arranged in adjacent layers on the at least one carrier element.

9. The fuse device according to claim 1, wherein:
the fuse element is configured to connect to an electrically positive connector of the at least one battery cell, and
the control unit comprises a switching element configured as an NPN bipolar transistor or as an N channel MOSFET.

10. The fuse device according to claim 1, wherein:
the fuse element is configured to connect to an electrically negative connector of the at least one battery cell, and
the control unit comprises a switching element configured as a PNP bipolar transistor or a P-channel MOSFET.

11. The fuse device according to claim 1, wherein the heating unit is configured and arranged for direct heating of an area of the fuse element.

12. The fuse device according to claim 1, wherein the heating unit is configured and arranged for direct heating of at least one surrounding area of the fuse element.

13. The fuse device according to claim 1, wherein the fuse element is configured and arranged to disconnect an electrically conductive connection between the heating unit and the at least one battery cell when triggered.

14. A rechargeable battery pack, comprising:
at least one battery cell; and
at least one fuse device according to claim 1 which is connected to the at least one battery cell.

15. A method for manufacturing a fuse device for a battery cell according to claim 1, wherein a fuse element and at least one heating element of a heating unit are applied to a printed circuit board.

16. The fuse device according to claim 1, wherein the heating unit is electrically connected and/or thermally connected and/or mechanically connected to the fuse element.
